(19) United States
(12) Patent Application Publication
(10) Pub. No.: US 2023/0279972 A1
(43) Pub. Date: Sep. 7, 2023

(54) SELF-REGULATING HEATED HOSE ASSEMBLY AND METHOD OF MAKING

(71) Applicant: Sykes Hollow Innovations, Ltd., East Dorset, VT (US)

(72) Inventors: William Ferrone, Dorset, VT (US); Christopher Ferrone, Spencertown, NY (US)

(21) Appl. No.: 18/005,905

(22) PCT Filed: Aug. 5, 2020
(86) PCT No.: PCT/US20/44984

§ 371 Date: Jan. 18, 2023

(51) Int. Cl. F16L 11/127; F16L 25/01; F16L 53/38; H05B 3/58

(52) U.S. Cl. CPC F16L 11/127; F16L 25/01; F16L 53/38; H05B 3/58; H05B 2203/016

(57) ABSTRACT

A self-regulated heated hose member, an assembly of self-regulated heated hose members, and methods of making the same are disclosed herein, including an inner core tube, a self-regulating heating element disposed along the outer surface of the inner core tube along its axial length, and an outer sheath layer disposed over the inner core tube and the self-regulating heating element.

### BACKGROUND OF THE INVENTION

The invention relates generally to electrically heated hoses. More particularly, the invention relates to a self-regulated heated hose member, an assembly of self-regulated heated hose members, and methods of making the same.

Electrically heated hoses are used in a number of applications in cold weather environments to carry fluid that would otherwise be susceptible to freezing under ambient conditions. Such applications vary widely in the fluids to be conveyed, the temperature and pressure conditions under which they must be conveyed, and the distance they must be conveyed. Examples include systems for injecting diesel exhaust fluid (DEF) from a reservoir into the combustion chamber of a diesel engine, which may be operated in a harsh or cold weather environment, hoses for hydraulic systems used in heavy construction equipment in cold weather environments, and water purification and potable water lines for use in cold weather environments.

Existing electrically heated hoses typically require the use of a thermostat or other device to control heating. Additionally, existing hoses are limited in the distance they are able to convey fluid because each heated hose member or segment must receive power directly from a power source such as an outlet. Existing hoses also suffer from manufacturing challenges related to, e.g., varying extrusion temperatures and melting points of the necessary components, and pressure limitations due to the application of hose fittings over relatively fragile electrical and/or heating components.

### BRIEF DESCRIPTION OF THE INVENTION

A first aspect of the disclosure provides a method of making a heated hose member, the method comprising the processes of: providing an inner core tube having a first end, a second end, an axial length from the first end to the second end, a lumen axially extending from the first end to the second end, and a radially outward facing surface; placing a self-regulating heating element on the radially outward facing surface of the inner core tube along the axial length; and layering an outer sheath layer over the radially outward facing surface of the inner core tube and the self-regulating heating element, thereby creating a first heated hose member. In such an embodiment, the inner core tube and the outer sheath layer are substantially concentric, and the self-regulating heating element is disposed between the radially outward facing surface of the inner core tube and an inner surface of the outer sheath layer.

A second aspect of the disclosure provides a heated hose member having a first end, a second end, and an axial length from the first end to the second end, the heated hose member comprising: an inner core tube having a lumen axially extending from the first end to the second end, and a radially outward facing surface; a self-regulating heating element disposed on the radially outward facing surface of the inner core tube along the axial length; and an outer sheath layer disposed over the radially outward facing surface of the inner core tube and the self-regulating heating element, wherein the inner core tube and the outer sheath layer are substantially concentric, and the self-regulating heating element is disposed between the radially outward facing surface of the inner core tube and an inner surface of the outer sheath layer.

A third aspect of the disclosure provides a heated hose assembly comprising: a first heated hose member as described in accordance with the second aspect, coupled in series to a second heated hose member as described in accordance with the second aspect. The resulting heated hose assembly provides linkage of both fluid passage and electrical heating from the first heated hose member to the second heated hose member, and may include two or more heated hose members coupled in series.

A fourth aspect of the disclosure provides a heated hose member prepared by the processes described herein.

These and other aspects, advantages and salient features of the invention will become apparent from the following detailed description, which, when taken in conjunction with the annexed drawings, disclose embodiments of the invention.

### BRIEF DESCRIPTION OF THE DRAWINGS

FIG. 1 provides a flow chart illustrating processes in a method according to an embodiment described herein.

FIG. 2 shows a side view of a heated hose member after completion of processes 1, 2, and 3 in the method of FIG. 1, according to an embodiment described herein.

FIG. 3 shows a cross sectional view of the heated hose member of FIG. 2, according to an embodiment described herein.

FIG. 4 shows a perspective view of a heated hose member after completion of process 4 in the method of FIG. 1, according to an embodiment described herein.

FIG. 5 shows a perspective view of a heated hose member after completion of processes 1, 1A, 2, 3, and 4 in the method of FIG. 1, according to an embodiment described herein.

FIG. 6 shows a perspective view of a heated hose assembly after completion of process 5 in the method of FIG. 1, according to an embodiment described herein.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

Various embodiments of the present invention are described below in reference to electrically heated hoses used in a number of commercial and industrial applications, as well as methods for making such hoses. Although certain hose embodiments are described relative to, e.g., electrically heated diesel exhaust fluid (DEF) hoses and hoses for carrying fluids such as, e.g., water in remote and/or cold weather environments, the methods and hoses described herein are equally applicable to hoses configured for deployment in a wide variety of industries, applications, and end uses, and having a broad range of inner and outer diameters, core materials, fitting types, pressure and temperature tolerances, and other variables. Additionally, such hoses may be used in connection with a range of electrical power sources, e.g., a 12 v battery or 120 v, 240 v, or 480 v circuits.

A number of embodiments of the present invention are described below in reference to a nominal size and including a set of nominal dimensions. However, it should be apparent to those skilled in the art that the present invention is likewise applicable to any suitable electrically heated hose. Further, it should be apparent to those skilled in the art that the present invention is likewise applicable to various scales of the nominal size and/or nominal dimensions.

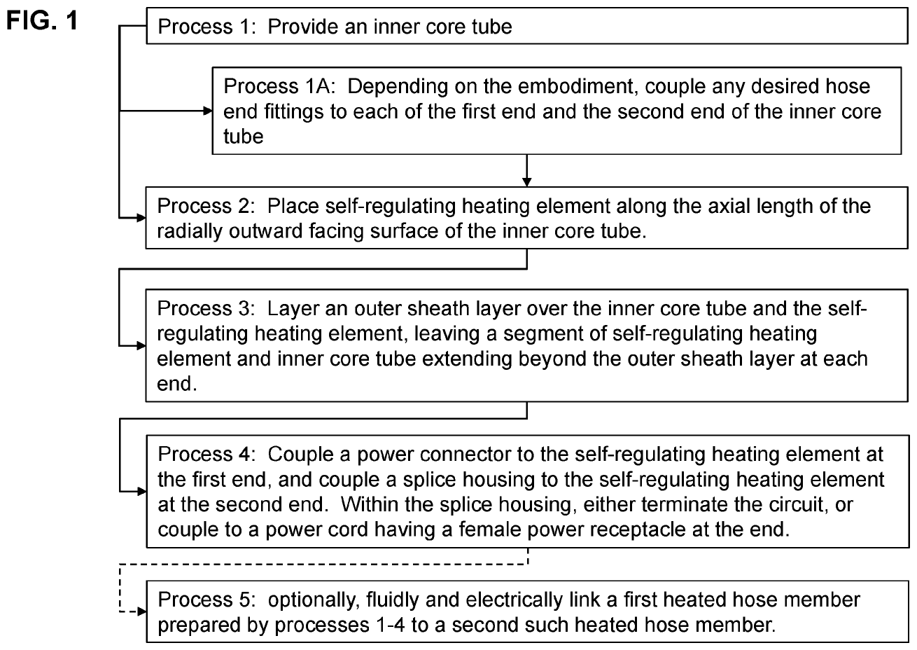

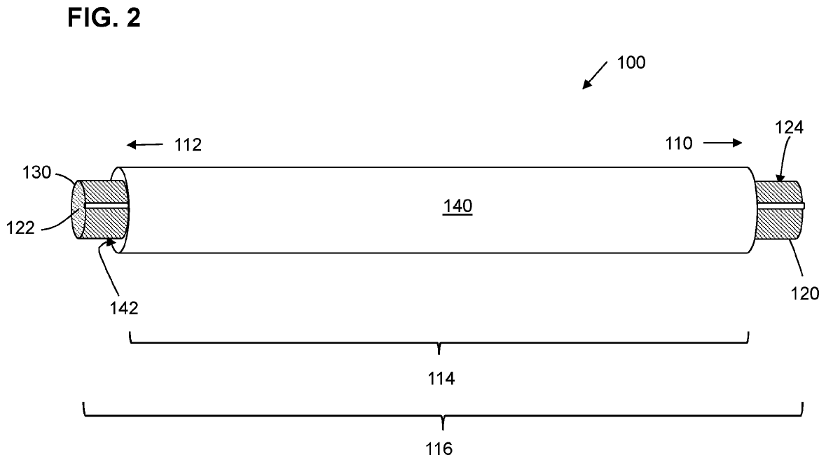

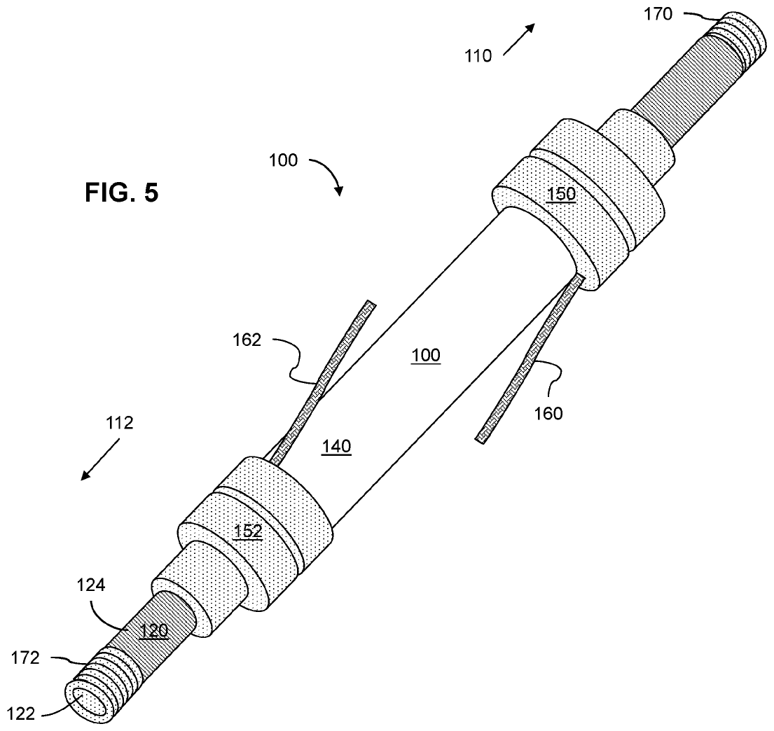

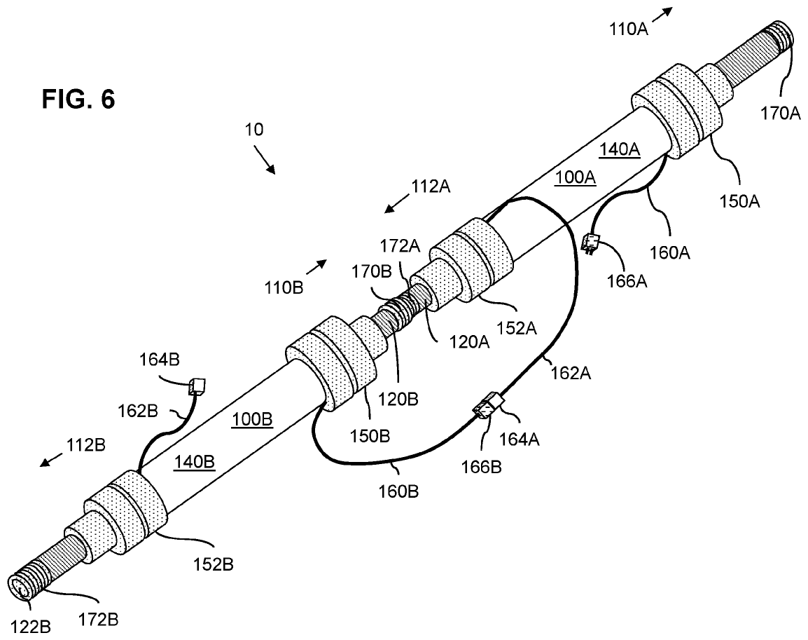

In an embodiment depicted in the flow chart of FIG. 1, processes are provided for making a heated hose member 100 (FIG. 5), and for making a heated hose assembly 10 (FIG. 6) of multiple, sequentially linked heated hose members 100A, 100B. FIGS. 2-5 illustrate components in the heated hose member 100 formed according to various embodiments, and are referred to in conjunction with the method in FIG. 1.

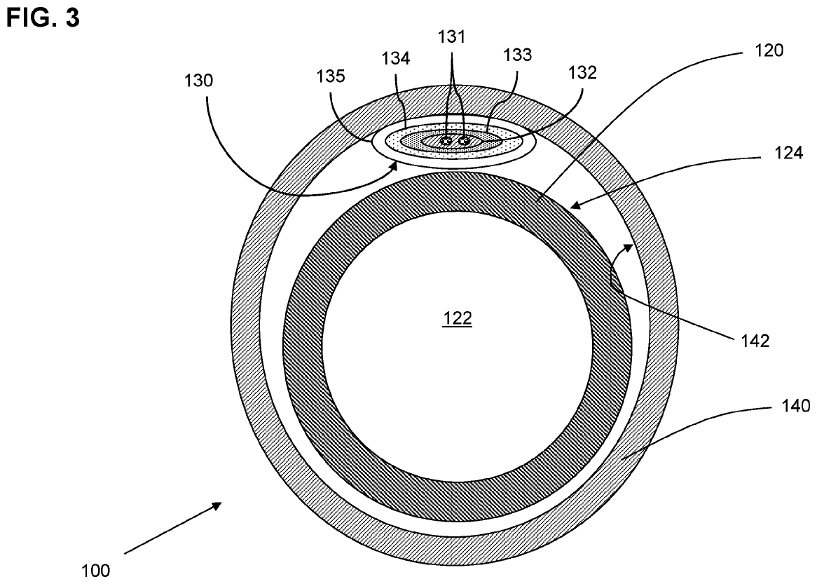

As noted above, FIG. 1 depicts an exemplary method for making a heated hose member 100 (FIG. 2), having a first end 110, a second end 112, and an axial length 116 extending from first end 110 to second end 112. The method depicted in FIG. 1 includes process 1, in which an inner core tube 120 (FIGS. 2-3) is provided.

As illustrated in FIG. 3, inner core tube 120 has a lumen 122 therein, and a radially outward facing surface 124. Lumen 122 in inner core tube 120 axially extends from the first end 110 of first heated hose member 100 to the second end 112 thereof (FIG. 2). The dimensions and materials of heated hose member 100 and components thereof may vary depending on the intended end use of a particular heated hose member 100, as described further herein. For example, the inner diameter of lumen 122 may be, e.g., about 6.35 mm (about 0.25 in.), about 8 mm, about 19.05 mm (about 0.75 in.), about 25.4 mm (about 1 in.), about 31.75 mm (about 1.25 in.), or any other desired hose inner diameter. The axial length 116 of heated hose member 100 may also vary, e.g., about 28 inches, about 10 meters, about 15 meters (about 50 feet), about 23 meters (about 75 feet), about 30 meters (about 100 feet), about 45 meters (about 150 feet), about 60 meters (about 200 feet), or any other typical or desired hose length. Inner core tube 120 may be made of any of a number of materials depending on the intended end use of heated hose member 100. By way of non-limiting example, inner core tube 120 may be made of ethylene propylene diene monomer (EPDM) rubber, polyvinyl chloride (PVC), polyurethane, neoprene, or any other material deployed in the art to make a flexible hose. In particular, inner core tube 120 may be made of an EPDM rubber inner layer, a polyester thread layer, and second, outer EPDM rubber layer.

With reference to FIG. 1, in optional process 1A, certain embodiments of the methods described herein may include coupling any desired hose end fittings to each of first end 110 and second end 112 of first heated hose member 100. For example, hose end fittings 170, 172 (FIG. 5) may be coupled to each of first end 110 and second end 112 of inner core tube 120, respectively. Fittings 170, 172 may be complementary such as, e.g., female and male fittings of the same type and size. The type of fitting 170 selected may vary with the intended end use of the heated hose member 100. By way of non-limiting example, fittings 170 may include stainless steel cam lock fittings, threaded hose fittings, hydraulic fittings, and other hose fittings as known in the art. In one embodiment, in process 1A, stainless steel cam lock female and male hose end fittings 170, 172 may be coupled to first end 110 and second end 112 of inner core tube 120 of a heated hose member 100 intended for use in carrying potable water. In other embodiments such as, e.g., methods for making a DEF hose, process 1A may be omitted, and the hoses may be affixed in their end use location using hose clamps or spring clamps in lieu of hose end fittings.

With reference to FIG. 1, in process 2, a self-regulating heating element 130 is placed on the radially outward facing surface 124 of the inner core tube 120, along the axial length 116. Self-regulating heating element 130 is also known in the art as self-regulating heat tracing cable or heat tape, and increases or decreases heat output in a self-regulated manner depending on the ambient temperature. This allows heated hose member 100 to operate without the need for a thermostat or on/off switch. In various embodiments, self-regulating heating element 130 may be arranged in a substantially linear fashion along inner core tube 120 (FIG. 2), while in other embodiments, self-regulating heating element 130 may be, e.g., wrapped circumferentially around inner core tube 120 in a spiral or helical pattern or other arrangement. Additionally, in some embodiments a single self-regulating heating element 130 may be used (as depicted in FIG. 3), while in other embodiments, multiple self-regulating heating elements may be placed along and/or around inner core tube 120 in a linear, spiral, or other arrangement to provide additional heat.

In continued reference to FIG. 1, in process 3, an outer sheath layer 140 is then layered over the radially outward facing surface 124 of inner core tube 120 and self-regulating heating element 130 (depicted in FIGS. 2-3). For example, outer sheath layer 140 may be extruded over inner core tube 120 and self-regulating heating element 130 using an extrusion machine. As a result, as illustrated in FIG. 3, inner core tube 120 and outer sheath layer 140 may be disposed substantially concentrically with respect to one another, and self-regulating heating element 130 is disposed between radially outward facing surface 124 of inner core tube 120 and an inner surface 142 of outer sheath layer 140. Outer sheath layer 140 is layered over inner core tube 120 and self-regulating heating element 130 such that, e.g., several centimeters or inches of axial length of inner core tube 120 and self-regulating heating element 130 extend beyond the outer sheath layer 140 at each of the first and second ends 110, 112, i.e., outer sheath layer 140 has an axial length 114 that is shorter than the axial length 116 of inner core tube 120 (FIG. 2). By way of non-limiting example, outer sheath layer 140 may be made of, e.g., PVC, EPDM rubber, polyurethane, neoprene, and other materials known in the art to deployed or deployable in the making of flexible hoses.

In still further embodiments, in lieu of processes 1-3 as shown in the flow diagram of FIG. 1, heated hose member 100 may be formed by extruding self-regulating heating element 130 into the wall of heated hose member 100. Such a method is not depicted herein, but is described, e.g., in U.S. Pat. Nos. 8,291,939; 8,863,782; and 9,077,134, each of which is incorporated by reference as though fully set forth herein.

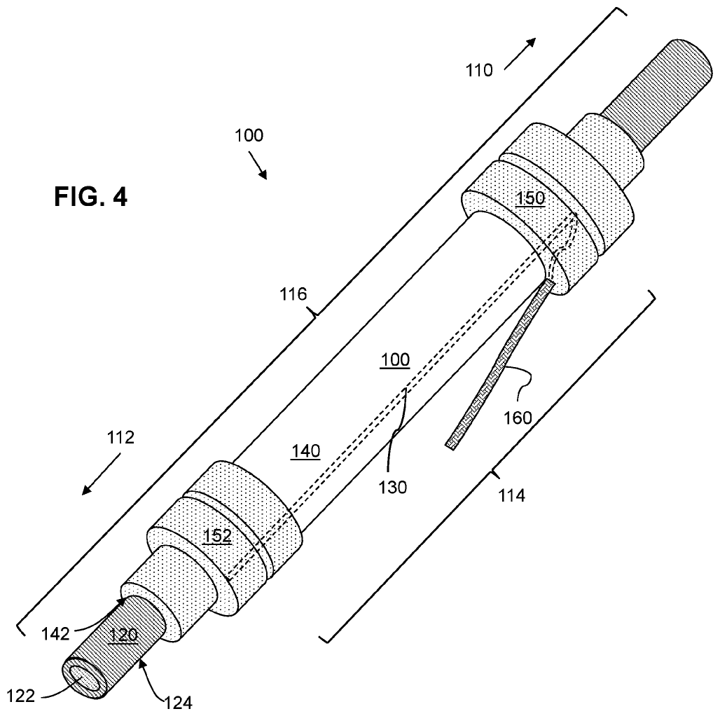

With reference to FIG. 1, regardless of the manner of assembling self-regulated heating element 130 and inner core tube 120, in process 4, a power connector 150 (FIG. 4) may be electrically coupled to self-regulating heating element 130 at first end 110 of heated hose member 100, particularly to the portion of self-regulating heating element 130 that extends beyond outer sheath layer 140 of heated hose member 100. Power connector 150 may be, e.g., a waterproof injection molded member or housing made of insulative material, having conductors disposed therein for delivering current via power cord 160 (FIG. 4) to the parallel conductors 131 (FIG. 3, described further herein) within self-regulating heating element 130. The portion of power connector 150 made of insulative material may further be layered over the end of outer sheath layer 140 such that outer sheath layer 140 terminates within power connector 150, while inner core tube 120 extends beyond power connector 150 by some length, e.g., by 3 cm, 4 cm or longer or shorter as desired. This length may be determined at least in part by the intended end use of heated hose member 100, as the length of power cord 160 and the portion of inner core tube 120 extending beyond power connector 150 may be dictated by the physical distance between the power source, i.e. source of the electrical current, and the source of the fluid intended to flow through heated hose member 100.

In various embodiments, power connector 150 and power cord 160 may provide a hard wired connection to a power source, e.g., power connector 150 and power cord 160 may include two wires disposed therein, coupled on one end to the parallel conductors 131 in self-regulating heating element 130 and on the other end, the power source which may be, e.g., a 12 v battery. For example, a two terminal multi-purpose connector with lead wires may be used as the power connector 150, with the lead wires serving as power cord 160, connecting to the ignition system of a vehicle or piece of machinery as a power supply. In other illustrative embodiments, the power supply may be a power outlet, e.g., 110 volt, and power connector 150 may be electrically connected thereto by electrical cord 160, which may or may not be grounded, and may include a male end plug (166A, 166B in FIG. 6) for plugging into the power outlet. Any other type of power connector 150 may also be used.

Additionally, splice housing 152 (FIGS. 4-5) may be coupled to heated hose member 100 at second end 112. Housing 152 may be injection molded or otherwise fashioned of insulative material, may be waterproof, and may include conductors disposed therein for receiving current from parallel conductors 131 (FIG. 3) within self-regulating heating element 130. In some embodiments, the circuit powering self-regulating heating element 130 may terminate at a terminal end disposed within housing 152 (FIG. 4). Alternatively, housing 152 may include a splice disposed therein, coupling self-regulating heating element 130 with a power cord 162 which may terminate at the opposite end in a female power receptacle 164A, 164B (FIGS. 5-6).

With further reference to FIG. 1 at process 5, fittings 170, 172 (FIGS. 5 and 6) may be used to facilitate the linkage of multiple heated hose members 100 in series to form a heated hose assembly 10 (FIG. 6). As shown in FIG. 6, two or more heated hose members 100A, 100B may be coupled or linked together by coupling a male hose fitting 172A on second end 112A of first heated hose member 100A, to a female hose fitting 170B on a first end 110B of a second heated hose member 100B. When the heated hose members 100A, 100B are linked, as shown in FIG. 6, the lumen 122 (FIG. 3) in the first heated hose member 100A is continuous with a lumen 122 (FIG. 3) in the second heated hose member 100B, providing linkable fluid lines. Additional heated hose members may be coupled in series, e.g., to heated hose member 100B, in the same manner as member 100B to member 100A. In an embodiment, a plurality of heated hose members 100A . . . 100F (100C, 100D, 100E, and 100F not shown) may be coupled in series to provide a single heated hose assembly 10 made of, e.g., six heated hose members 100A . . . 100F. Heated hose assembly 10 may be, e.g., up to about 60 meters (about 200 ft.) in length, and may be made up of a plurality of heated hose members 100, each of which may be, e.g., about 10 meters, about 15 meters (about 50 feet), about 23 meters (about 75 feet), about 30 meters (about 100 feet), or any other typical or desired hose length. Any number of heated hose members 100 may be coupled together to form heated hose assembly 10.

As further shown in FIG. 6, in addition to heated hose members 100A, 100B being fluidly linked, self-regulating heating elements 130 (FIG. 3) of each of heated hose members 100A, 100B may be electrically coupled, carrying power from one heated hose member 100A to the next heated hose member 100B in series, thereby providing linkable heating. Such linkage may be accomplished by electrically coupling self-regulating heating element 130 (FIG. 3) of heated hose member 100A at the second end 112 thereof, to a self-regulating heating element 130 (FIG. 3) of heated hose member 100B at the first end 110 thereof. As previously described and as illustrated in FIG. 6, heated hose member 100A includes housing 152A, which may further include a splice therein coupling the self-regulated heating element (not shown in FIG. 6; see 130 in FIGS. 3-4) of heated hose member 100A, to power cable 162A (FIGS. 5-6). Power cable 162A may end with power receptacle 164A (FIG. 6). Power receptacle 164A may be coupled to a complementary power receptacle 166B of heated hose member 100B. In various embodiments, power receptacles 164A, 164B may be female power plugs, and power receptacles 166A, 166B may be male power plugs. Electric current is provided to and through heated hose member 100B in a manner analogous to the manner described relative to heated hose member 100 above.

In other embodiments, where linkage is not desired, or where a heated hose member 100 is intended to be the final linked heated hose member in series, power cord 162B and power receptacle 166B (in FIG. 6) may be omitted (not shown), and a terminal end may instead be disposed within the housing 152, as shown in FIG. 4.

Embodiments of the invention also include a heated hose member or segment product, and a hose assembly product made of hose members or segments that are prepared by the process described herein and in FIG. 1.

Turning particularly to FIGS. 2-6, embodiments of the invention disclose a heated hose member 100 (FIGS. 2-5) and a heated hose assembly 10 composed of two or more serially connected heated hose members 100 (FIG. 6, heated hose members 100A, 100B). The dimensions and materials of heated hose members 100 and components thereof may vary depending on the intended end use of a particular heated hose member 100. For example, EPDM rubber may be selected for use in making inner core tube 120 for applications requiring particular resistance to environmental conditions in which the hose may be used. EPDM rubber also provides a relatively high melting point, allowing for extrusion of outer sheath layer 140 over inner core tube 120, for example at temperatures associated with extrusion of, e.g., PVC, without affecting the structure of inner core tube 120.

In various embodiments, as shown in FIG. 2, heated hose member 100 has a first end 110, a second end 112, and an axial length 116 from the first end 110 to the second end 112. An inner core tube 120 is provided, having a lumen 122 therein that extends axially from first end 110 to second end 112, as well as a radially outward facing surface 124. As noted, the dimensions of heated hose member 100 may vary with the intended end use, however non-limiting exemplary inner diameters of lumen 122 may be, e.g., about 5 to about 32 mm, or particularly about 6.35 mm (about 0.25 in.), about 8 mm, about 19.05 mm (about 0.75 in.), about 25.4 mm (about 1 in.), or about 31.75 mm (about 1.25 in.). The axial length 116 of heated hose member 100 may also vary, e.g., from about 71 cm (about 28 inches) to about 60 meters (about 200 feet), e.g., about 10 meters, about 15 meters (about 50 feet), about 23 meters (about 75 feet), about 30 meters (about 100 feet), about 45 meters (about 150 feet), about 60 meters (about 200 feet), or any other typical or desired hose length. Inner core tube 120 may be made of any of a number of materials depending on the intended end use of heated hose member 100. By way of non-limiting example, inner core tube 120 may be made of EPDM rubber, PVC, polyurethane, neoprene, and other materials known in the art to be deployed or deployable in the making of flexible hoses. In particular, inner core tube 120 may be made of an EPDM rubber inner layer, a polyester thread layer, and second, outer EPDM rubber layer.

A self-regulating heating element 130 is disposed on radially outward facing surface 124 of inner core tube 120 along the axial length 116 from first end 110 to second end 112. Self-regulating heating element 130 may be arranged in a substantially linear fashion, or may be wrapped circumferentially in a spiral or helical pattern or other arrangement about inner core tube 120.

Self-regulating heating element 130 is also known in the art as self-regulating heat tracing cable or heat tape. As shown in FIG. 3, self-regulating heating element 130 includes two parallel conductors 131, e.g., wires embedded in a conductive core 132. Conductive core 132 is disposed within an inner insulation jacket 133, which is itself disposed within a ground layer 134 of, e.g., copper braid which provides a ground path and additional protection. Finally, a protective outer jacket 135, which may be made of, e.g., PVC, silicone, or other insulating material is disposed around ground layer 134. Conductive core 132 may be, e.g., carbon doped polymer. In low ambient temperatures, conductive core 132 contracts, bringing more conductive cells into contact with one another and increasing current flow between the two parallel conductors 131 and turning conductive core 132 into a resistive heating element. In warmer ambient temperatures, conductive core 132 expands, breaking the circuit between the two parallel conductors 131 and decreasing the heat generated. Because the expansion or contraction of conductive core 132 is localized to the position along axial length 116 (FIG. 2) of self-regulating heating element 130 that is subject to a given ambient temperature, self-regulating heating element 130 provides variable heating along its entire axial length 116. Although self-regulating heating element 130 does not fully turn on or off in this manner, in various implementations, the heat output is self-regulated without the need for a thermostat or on/off switch.

As shown in FIGS. 2-3, outer sheath layer 140 is disposed over radially outward facing surface 124 of inner core tube 120 and self-regulating heating element 130, such that inner core tube 120 and outer sheath layer 140 may be disposed approximately or substantially concentrically with respect to one another, and self-regulating heating element 130 is disposed between radially outward facing surface 124 of inner core tube 120 and an inner surface 142 of outer sheath layer 140 (FIG. 3). As shown in FIG. 2, axial length 114 of outer sheath layer 140 is shorter than axial length 116 of inner core tube 120 and self-regulating heating element 130, such that inner core tube 120 and self-regulating heating element 130 extend beyond outer sheath layer 140 at each of first and second ends 110, 112, e.g. by several centimeters or inches. In certain embodiments, outer sheath layer 140 may have an outer diameter of about 14 mm, although any outer diameter may be used. By way of non-limiting example, outer sheath layer 140 may be made of, e.g., PVC, EPDM rubber, polyurethane, neoprene, and other materials known in the art to deployed or deployable in the making of flexible hoses.

As shown in FIG. 4, a power connector 150 may be coupled to heated hose member 100 at first end 110. Power connector 150 is configured to couple an electrical power supply to self-regulating heating element 130 at first end 110, to deliver current thereto. Power connector 150 may take any of a number of specific forms, depending on the source of the electric current and the degree of permanence of the installation, i.e. whether heated hose member 100 is intended for permanent installation such as hard wiring in its intended end use, or whether it is intended for more temporary or flexible use, and may be powered by a plugged-in connection.

Power connector 150 may be made of insulative material, having conductors disposed therein for delivering current to the parallel conductors 131 (FIG. 3) within self-regulating heating element 130. In some embodiments, power connector 150 may be injection molded. The source of the current may be a battery or circuit, and self-regulating heating element 130 may be hard wired using two wires within power connector 150, the wires each being coupled on one end to one of the two parallel connectors 131 in self-regulating heating element 130, and on the other end, to the power source. In such embodiments, the power source may include, e.g., a 12 v battery. In other embodiments, self-regulating heating element 130 may be coupled within power connector 150 to a power cord 160, which may be grounded, and power cord 160 may terminate at the other end with plug 166 (166A, FIG. 6). Plug 166 (e.g. 166A or 166B in FIG. 6) may particularly be a male end power receptacle. Plug 166 (e.g. 166A or 166B in FIG. 6) may be coupled to the electrical power supply, which may be a power outlet, e.g., 110 volt.

As shown in FIGS. 4-5, a splice housing 152 may be coupled to heated hose member 100 at second end 112. Housing 152 may be injection molded or otherwise fashioned of insulative material, and may include conductors disposed therein for receiving current from parallel conductors 131 (FIG. 3) within self-regulating heating element 130. In some embodiments, the circuit powering self-regulating heating element 130 may terminate at a terminal end disposed within housing 152 (FIG. 4). Alternatively, housing 152 may include a splice disposed therein, coupling self-regulating heating element 130 with a power cord 162 (FIG. 5) which may terminate at the opposite end in a power receptacle 164, e.g., a female power plug 164A, 164B (FIG. 6).

Some embodiments may include further hose end fittings 170, 172 disposed on each of first end 110 and second end 112 of inner core tube 120, respectively, as shown in FIG. 5. Fittings 170, 172 are complementary to one another, e.g., fittings 170 and 172 may be female and male fittings of the same type and size. The type of fitting 170 selected may vary with the intended end use of the hose member 100. By way of non-limiting example, fittings 170 may include stainless steel cam lock fittings, threaded hose fittings, hydraulic fittings, and other hose fittings as known in the art.

Fittings 170, 172 may be configured to facilitate the fluid linkage of multiple heated hose members 100A, 100B in series to form a heated hose assembly 10 (FIG. 6). Two or more heated hose members 100A, 100B may be coupled or linked together by coupling a hose fitting 172A on second end 112A of first heated hose member 100A, to a complementary hose fitting 170B on a first end 110B of a second heated hose member 100B. When the heated hose members 100A, 100B are linked as shown in FIG. 6, lumen 122 (FIGS. 2-3) in first heated hose member 100A is continuous with lumen 122 (FIGS. 2-3) in second heated hose member 100B, providing linkable fluid lines.

As further shown in FIG. 6, in addition to providing fluid linkage between the lumens of the heated hose members 100A, 100B, the self-regulating heating elements 130 of each of heated hose members 100A, 100B may be electrically linked, carrying power from one heated hose member 100A to the next member 100B in series to provide linkable heating. In such an embodiment, current is delivered to self-regulating heating element 130 (shown in FIGS. 2-3) of heated hose member 100A from the power source via power cord 160A (FIG. 6), which may include power receptacle 166A. Power cord 160A may be spliced to self-regulating heating element 130 (not visible in FIG. 6) within power connector 150A. Current is carried through self-regulating heating element 130 (not visible in FIG. 6) within heated hose member 100A to housing 152A, within which self-regulating heating element 130 (not visible in FIG. 6) may be spliced to power cord 162A. Power cord 162A may then carry power onward to a power receptacle 164A, which may be, e.g., a female end plug. Power receptacle 166B is complementary with and configured to be electrically connected, e.g., plugged into power receptacle 164A of heated hose member 100A. In this manner, power is delivered to the entire heated hose assembly 10 using a single connection to the source of the current, e.g. power cord 160A which may include power receptacle 166A.

Additional heated hose members 100 may be coupled in series, e.g., to heated hose member 100B, in a manner analogous to the coupling of heated hose member 100B to heated hose member 100A. In various embodiments, a plurality of heated hose members 100A, 100B . . . may be coupled in series to provide a single heated hose assembly 10. For example, in an embodiment of heated hose assembly 10 including six heated hose members 100, heated hose member 100A may be coupled to heated hose member 100B (FIG. 6), may be coupled to a heated hose member 100C, may be coupled to a heated hose member 100D, may be coupled to a heated hose member 100E, may be coupled to a heated hose member 100F (100C, 100D, 100E, and 100F not shown). In embodiments in which each heated hose member 100 has an axial length 116 (FIG. 2) of, e.g., about 71 cm (about 28 inches), about 10 meters, about 15 meters (about 50 feet), about 23 meters (about 75 feet), about 30 meters (about 100 feet), or any other typical or desired hose length, heated hose assembly 10 may have a length of, e.g., up to about 60 meters (about 200 ft.), all powered by a single connection via power connector 150A and power cord 160A to the source of the current.

The skilled artisan will appreciate that additional preferred embodiments may be selected by combining the preferred embodiments above, or by reference to the examples given herein.

### Example 1

An electrically heated hose member 100 may be made for deployment as a diesel exhaust fluid (DEF) hose for use in a selective catalytic reduction (SCR) system. According to this embodiment, a first heated hose member 100 is created, having a first end 110, a second end 112, and an axial length 116 extending from first end 110 to second end 112 (FIG. 2). An inner core tube 120 is provided, having a lumen 122 therein, and a radially outward facing surface 124. The inner diameter of lumen 122 is about 0.25 inch (6.35 mm) or about 8 mm, the outer diameter of inner core tube 120 is about 14 mm, and the axial length 116 of heated hose member 100 is about 28 inches. The inner core tube is made of EPDM rubber, and more particularly may be an EPDM rubber inner layer, a polyester thread layer, and second, outer EPDM rubber layer. Attributes of an exemplary EPDM rubber which may be used in forming inner core tube 120 are provided in Table 1.

TABLE 1
EPDM attributes

| | | | | Testing |
|---|---|---|---|---|
| Feature | unit | Standard | | result |
| Rigidity HRA | HRA | 65 ± 5 | | 67 |
| Tensile strength | Mpa | ≥7.0 | | 7.6 |
| elongation at break | % | ≥250 | | 347 |
| Rigidity after air aging | HRA | 15 | | 2 |
| 110 C.*72 h- | | | | |
| Tensile strength after air aging | % | ±25 | | 5 |
| 110 C.*72 h- | | | | |
| extension rate after air aging | % | 10-−30 | | −13 |
| 110 C.*72 h- | | | | |
| brittleness temperature | ° C. | −40 C. No crack | | No crack |
| Ozone aging resistance | | No crack | | No crack |
| 40 C.*70 hour | | | | |
| burst pressure | Mpa | ≥0.6 | | 0.9 |
| Diameter tolerance | % | 15 | | 5 |
| Adhesive strength | KN/M | ≥1.2 | | 1.3 |
| Diameter mm | mm | 8 | (0.31 inch) | |
| Outer diameter | mm | 14 | 0.55 inch) | |

Further, an EPDM rubber inner core tube 120 having 0.25 inch inner diameter may meet IATF 16949 standard.

A self-regulating heating element 130 is placed on the radially outward facing surface 124 of the inner core tube 120, along the axial length 116 from the first end 110 to the second end 112. An outer sheath layer 140 is then extruded over the radially outward facing surface 124 of inner core tube 120 and self-regulating heating element 130. As a result, inner core tube 120 and outer sheath layer 140 are disposed substantially concentrically with respect to one another, and self-regulating heating element 130 is disposed between radially outward facing surface 124 of inner core tube 120 and an inner surface 142 of outer sheath layer 140 (FIG. 2). Outer sheath layer 140 is polyvinyl chloride (PVC), and has an axial length 114 that is shorter than that 116 of inner core tube 120, such that inner core tube 120 extends beyond outer sheath layer 140 at each end 110, 112.

Power connector 150 may be coupled to heated hose member 100 at first end 110 at the termination of outer sheath 140, i.e., where self-regulated heating element 130 is exposed. Power connector 150 is configured, as shown in FIG. 4, to couple self-regulated heating element 130 to an electrical power supply, e.g., a 12 v battery, via hard wired connection using, e.g., bolts, wingnuts, clamps, solder, or other means as known in the art. A splice housing 152 is coupled to heated hose member 100 at second end 112. In this embedment, the circuit is terminated within member 152.

The foregoing exemplary heated hose member 100 is configured to be coupled to a fluid source and fluid output using a conventional means of fixation such as, e.g., spring clamps. Self-regulating heating element 130 may draw about 8 watts/ft. of element (cable), ±5%, and delivers self regulated heat such that temperature performance within inner core tube 120 is observed as described in Table 2.

TABLE 2
Observed temperature self-regulation

| | |
|---|---|
| Ambient temperature | Temperature within inner core tube 120 |

| | | | |
|---|---|---|---|
| 10° | C. | 55° | C. |
| 0° | C. | 40° | C. |
| −20° | C. | 15-25° | C. |

−40° C. is the minimum temperature at which a heated hose member 100, configure as described in the present example, should be installed.

### Example 2

An electrically heated hose member 100 may be made for deployment as a diesel exhaust fluid (DEF) hose component product. In this embodiment, a first heated hose member 100 is created, having a first end 110, a second end 112, and an axial length 116 extending from first end 110 to second end 112 (FIG. 2). An inner core tube 120 is provided, having a lumen 122 therein, and a radially outward facing surface 124. The inner diameter of lumen 122 is about 0.25 inch (6.35 mm) or about 8 mm, the outer diameter of inner core tube 120 is about 14 mm, and the axial length of heated hose member 100 is about 28 inches. The inner core tube is made of EPDM rubber, and more particularly may be an EPDM rubber inner layer, a polyester thread layer, and second, outer EPDM rubber layer. Inner core 120 may have attributes similar to those described with respect to Example 1.

A self-regulating heating element 130 is placed on the radially outward facing surface 124 of the inner core tube 120, along the axial length 116. An outer sheath layer 140 is then extruded over the radially outward facing surface 124 of inner core tube 120 and self-regulating heating element 130. As a result, inner core tube 120 and outer sheath layer 140 are disposed substantially concentrically with respect to one another, and self-regulating heating element 130 is disposed between radially outward facing surface 124 of inner core tube 120 and an inner surface 142 of outer sheath layer 140 (FIG. 2). Outer sheath layer 140 is polyvinyl chloride (PVC), and has an axial length 114 that is shorter than that 116 of inner core tube 120, such that inner core tube 120 extends beyond outer sheath layer 140 at each end 110, 112 (FIG. 2).

Power connector 150 is coupled to heated hose member 100 at the termination of outer sheath layer 140 at first end 110. Power connector 150 allows for the coupling of an electrical power supply to the self-regulating heating element 130 at first end 110. Power connector 150 is configured to be hard-wired using, e.g., bolts, wingnuts, clamps, solder, etc. to couple the conductors to the electrical power supply, which may be, e.g., a 12 v battery. A splice housing 152 is coupled to heated hose member 100 at the termination of outer sheath 140 at second end 112. The circuit is terminated within member 152 as shown in FIG. 4. The foregoing exemplary heated hose member 100 is configured to be coupled to a fluid source and fluid output using a conventional means of fixation such as, e.g., spring clamps in lieu of hose fittings 170, 172.

### Example 3

With reference to FIGS. 5-6, an electrically heated hose assembly 10 (FIG. 6) is made for deployment in carrying fluids, e.g., for use in a water purification system and/or for carrying potable water in remote, cold weather environments. In such an embodiment, a first heated hose member 100 is created, having a first end 110, a second end 112, and an axial length 116 (FIG. 4) extending from first end 110 to second end 112. To form first heated hose member 100, an inner core tube 120 is provided, having a lumen 122 therein and a radially outward facing surface 124.

The particular material and diameter of inner core tube 120 may be selected depending on the anticipated demands of the environment in which the hose will be deployed, the type of fluid that will flow through the inner core tube, and other factors. Table 3 (below) provides the specifications of three heated hoses having non-limiting and exemplary features and dimensions which may be used as inner core tube 120 in making heated hose member 100. In the exemplary one (1) inch inner diameter hose described in Table 3, the material(s) used to form inner core tube 120 may be, e.g., an EPDM synthetic rubber, RMA class C (limited oil resistance), with spiral synthetic yarn. In the exemplary 1.25-inch inner diameter hose described in Table 3, the inner core tube may be, e.g., an EPDM blend with abrasion and weather-resistant EPDM blend cover, and high tensile synthetic cord with helical steel wire.

TABLE 3
Specifications of three example hoses according to Example 3

| | Axial | | | Temp | | |
|---|---|---|---|---|---|---|
| ID | length | | Pressure | tolerance | Electrical | |
| (in.) | (m) | Fittings | (psi) | (down to) | connections | Power |
| 1.25 | 10 | 316L | Up to | −40° C. | NEMA 5 or | 120 v or |
| | | stainless | 150 psi | | NEMA 6 | 220 v |
| | | steel cam | | | | |
| | | lock | | | | |
| 1 | 10 | 316L | Up to | −40° C. | NEMA 5 or | 120 v or |
| | | stainless | 150 psi | | NEMA 6 | 220 v |
| | | steel cam | | | | |
| | | lock | | | | |
| 0.75 | 10 | 316L | Up to | −40° C. | NEMA 5 or | 120 v or |
| | | stainless | 150 psi | | NEMA 6 | 220 v |
| | | steel cam | | | | |
| | | lock | | | | |

Abbreviations used in Table 3 include: ID (inner diameter of inner core tube 120), and NEMA (National Electrical Manufacturers Association). Axial length refers to axial length 116 (FIG. 4); fittings refer to fittings 170, 172 (FIG. 5).

Female and male hose fittings 170, 172 are further coupled to each of first end 110 and second end 112 of first heated hose member 100, respectively, as shown in FIG. 5. Fittings 170, 172 are complementary, e.g., female and male fittings of the same type and size, e.g., stainless steel cam lock fittings (Table 3), threaded hose fittings, hydraulic fittings, and other hose fittings as known in the art.

A self-regulating heating element 130 is then placed on the radially outward facing surface 124 of the inner core tube 120, along the axial length 116. An outer sheath layer 140 is then extruded over the radially outward facing surface 124 of inner core tube 120 and self-regulating heating element 130. Following extrusion, inner core tube 120 and outer sheath layer 140 are disposed substantially concentrically with respect to one another, and self-regulating heating element 130 is disposed between radially outward facing surface 124 of inner core tube 120 and an inner surface 142 of outer sheath layer 140 (FIG. 3). The axial length 114 of outer sheath layer 140 is shorter than that 116 of inner core tube 120, such that inner core tube 120 extends beyond outer sheath layer 140 at each end 110, 112 (FIG. 4). By way of non-limiting example, outer sheath layer 140 may be made of, e.g., PVC, EPDM rubber, polyurethane, neoprene, or any other material useful for deployment in the making of flexible hoses, and may be color coded using ASME standards, see Table 4, for ease of identification in the field.

TABLE 4
ASME standard color combinations

| | New standard | |
|---|---|---|
| | ASME A13.1-2007 | Old standard ASME |
| Color combinations | (R2013) | A13.1-1996 (R2002) |
| White markings on red | Fire quenching | Fire quenching |
| | fluids | fluids |
| Black markings on orange | Toxic and corrosive | |
| | fluids | |
| Black markings on yellow | Flammable fluids | Hazardous materials |
| | | Flammable or |
| | | explosive |
| | | Chemically active or |
| | | toxic |
| | | Extreme temperatures |
| | | or pressures |
| | | Radioactive |
| White markings on brown | Combustible fluids | — |
| White markings on green | Potable, cooling, | Low hazard materials |
| | boiler feed, and | |
| | other water | |
| White markings on blue | Compressed air | Low hazard gases |
| White markings on purple | User defined | — |
| Black markings on white | User defined | — |
| White markings on gray | User defined | — |
| White markings on black | User defined | — |

A power connector 150 is coupled to heated hose member 100 at first end 110. Power connector 150 may be, e.g., an injection molded NEMA 5 or NEMA 6 rated connector configured to couple an electrical power supply to self-regulating heating element 130 at first end 110. Power connector 150 may include conductors disposed therein which are coupled via a splice to each of the parallel conductors 131 (FIG. 3) in self-regulating heating element 130 at first end 110, and to the conductors in an electrical cord 160 for coupling self-regulating heating element 130 to an electrical power supply. Electrical cord 160 may end with a male power plug 166A, 166B (FIG. 6).

A splice housing 152, which may be injection molded or otherwise fashioned, may further be coupled to heated hose member 100 at second end 112 as shown in, e.g., FIGS. 4-5. Housing 152 may contain conductors which are spliced to each of the parallel conductors 131 (FIG. 3) in self-regulating heating element 130 at second end 112. In the embodiment shown in FIG. 4, a terminal splice may be contained within housing 152, while the embodiment of FIG. 5 illustrates coupling of the second end 112 of self-regulating heating element 130 to power cord 162 via conductors in housing 152. Power cord 162 may terminate with a female plug 164A, 164B (FIG. 6).

Fittings 170, 172 facilitate the linkage of multiple heated hose members 100 in series to form a heated hose assembly 10. A plurality of heated hose members 100A, 100B . . . may be coupled or linked together by coupling a hose fitting 172A on second end 112A of first heated hose member 100A, to a complementary hose fitting 170B on a first end 110B of a second heated hose member 100B, thereby providing linkable fluid lines.

As further shown in FIG. 6, in addition to fluidly linking the heated hose members 100A, 100B, the self-regulating heating elements 130 of each of heated hose members 100A, 100B may be electrically coupled, carrying power from one heated hose member 100A to the next 100B in series. Such linkable heating may be accomplished by plugging male power receptacle 166B of the second heated hose member 100B into female power receptacle 164A of the first heated hose member 100A, as shown in FIG. 6, rather than coupling both of heated hose members 100A, 100B directly into power sources.

As used herein, the terms “first,” “second,” and the like, do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the material(s) includes one or more materials). Ranges disclosed herein are inclusive and independently combinable (e.g., ranges of “up to about 25 mm, or, more specifically, about 5 mm to about 20 mm,” is inclusive of the endpoints and all intermediate values of the ranges of “about 5 mm to about 25 mm,” etc.).

While various embodiments are described herein, it will be appreciated from the specification that various combinations of elements, variations or improvements therein may be made by those skilled in the art, and are within the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A method, comprising:
providing an inner core tube having a first end, a second end, an axial length from the first end to the second end, a lumen axially extending from the first end to the second end, and a radially outward facing surface;
placing a self-regulating heating element on the radially outward facing surface of the inner core tube along the axial length; and
layering an outer sheath layer over the radially outward facing surface of the inner core tube and the self-regulating heating element, thereby forming a first heated hose member,
wherein the inner core tube and the outer sheath layer are substantially concentric, and the self-regulating heating element is disposed between the radially outward facing surface of the inner core tube and an inner surface of the outer sheath layer.

2. The method of claim 1, wherein the process of layering the outer sheath layer further comprises extruding the outer sheath layer.

3. The method of claim 1, wherein the process of layering the outer sheath layer further comprises leaving a first portion of the inner core tube and the self-regulating heating element exposed at the first end, and a second portion of the inner core tube and the self-regulating heating element exposed at the second end; and
at the first end, coupling a power connector to the first portion of the self-regulating heating element exposed at the first end.

4. (canceled)

5. The method of claim 3, wherein the power connector includes an electrical cord configured to be plugged into a power outlet.

6. The method of claim 3, wherein the power connector includes a hard wired connection to a battery or an electrical circuit.

7. The method of claim 3, further comprising:
at the second end, coupling a splice housing to the second portion of the self-regulating heating element exposed at the second end.

8. The method of claim 7, wherein the splice housing includes a terminal splice.

9. The method of claim 7, wherein the splice housing includes a power cord configured to terminate with a female power receptacle, and the process of coupling the splice housing includes electrically coupling the self-regulating heating element with the power cord.

10. The method of claim 9, further comprising coupling a hose fitting to each of the first end and the second end of the first heated hose member, wherein the hose fitting on the first end is configured to provide a complementary fit with the hose fitting on the second end.

11. The method of claim 10, further comprising:
forming a second heated hose member according to the processes used to form the first heated hose member;
coupling a hose fitting on a first end of the second heated hose member to the hose fitting on the second end of the first heated hose member, such that the lumen in the first heated hose member is continuous with a lumen in the second heated hose member; and
electrically coupling a first end of a self-regulating heating element in the second heated hose member with the power cord of the first heated hose member.

12. A heated hose member having a first end, a second end, and an axial length from the first end to the second end, comprising:
an inner core tube having a lumen axially extending from the first end to the second end, and a radially outward facing surface;
a self-regulating heating element disposed on the radially outward facing surface of the inner core tube along the axial length; and
an outer sheath layer disposed over the radially outward facing surface of the inner core tube and the self-regulating heating element,
wherein the inner core tube and the outer sheath layer are substantially concentric, and the self-regulating heating element is disposed between the radially outward facing surface of the inner core tube and an inner surface of the outer sheath layer.

13. The heated hose member of claim 12, wherein the inner core tube comprises ethylene propylene diene monomer (EPDM) rubber.

14. The heated hose member of claim 13, wherein the inner core tube includes a first, inner layer of EPDM rubber, a polyester thread layer, and a second, outer layer of EPDM rubber.

15. The heated hose member of claim 12, wherein an inner diameter of the lumen is about 8 mm, and an outer diameter of the outer sheath layer is about 14 mm.

16. The heated hose member of claim 12, wherein the outer sheath layer comprises polyvinyl chloride (PVC).

17. The heated hose member of claim 12, further comprising:
a first hose fitting coupled to the first end of the inner core tube;
a second hose fitting coupled to the second end of the inner core tube; and
a power connector electrically coupled to the self-regulating heating element at the first end, the power connector being configured to deliver a current from a power source to the self-regulating heating element; and
a splice housing electrically coupled to the self-regulating heating element at the second end.

18. (canceled)

19. The heated hose member of claim 17, further comprising a terminal splice within the splice housing;
a power cord electrically coupled to the self-regulating heating element within the splice housing, the power cord including a female power receptacle;
a first hose fitting coupled to the first end of the inner core tube; and
a second hose fitting coupled to the second end of the inner core tube, wherein the second fitting is complementary to the first fitting.

20-21. (canceled)

22. The heated hose member of claim 12, wherein an inner diameter of the lumen is from about 6 mm to about 32 mm;
wherein the axial length is up to about 10 meters;
wherein the heated hose member has a pressure tolerance of up to 150 psi; and
wherein the heated hose member has a temperature tolerance range of −40° F. to 190° F.

23-25. (canceled)

26. A heated hose assembly comprising:
a first heated hose member coupled to a second heated hose member, wherein each of the first and the second heated hose members comprises:
a first end, a second end, and an axial length extending from the first end to the second end;
an inner core tube having a lumen axially extending from the first end to the second end, and a radially outward facing surface;
a self-regulating heating element disposed on the radially outward facing surface of the inner core tube along the axial length;
an outer sheath layer disposed over the radially outward facing surface of the inner core tube and the self-regulating heating element,
wherein the inner core tube and the outer sheath layer are substantially concentric, and the self-regulating heating element is disposed between the radially outward facing surface of the inner core tube and an inner surface of the outer sheath layer;
a power connector electrically coupled to the self-regulating heating element at the first end, the power connector being configured to deliver a current from a power source to the self-regulating heating element;
a splice housing electrically coupled to the self-regulating heating element at the second end;
a power cord electrically coupled to the self-regulating heating element within the splice housing, the power cord including a female power receptacle,
a first hose fitting coupled to the first end of the inner core tube; and
a second hose fitting coupled to the second end of the inner core tube,
wherein the second hose fitting is complementary to the first hose fitting, and the first hose fitting of the second heated hose member is coupled to the second hose fitting of the first heated hose member.

27. A heated hose member prepared by the process of claim 1.
